(19) United States
(12) Patent Application Publication
(10) Pub. No.: US 2017/0108967 A1
(43) Pub. Date: Apr. 20, 2017

(54) CAPACITANCE VALUE DISTRIBUTION DETECTION CIRCUIT, TOUCH PANEL SYSTEM, AND ELECTRONIC DEVICE

(71) Applicant: Sharp Kabushiki Kaisha, Osaka (JP)

(72) Inventor: Mutsumi HAMAGUCHI, Osaka (JP)

(73) Assignee: Sharp Kabushiki Kaisha, Osaka (JP)

(21) Appl. No.: 15/310,552

(22) PCT Filed: Jun. 16, 2015
(86) PCT No.: PCT/JP2015/067351

§ 371 Date: Nov. 11, 2016

(30) Foreign Application Priority Data
Jul. 7, 2014 (JP) 2014-139531

(51) Int. Cl. G06F 3/044; G06F 3/041

(52) U.S. Cl. CPC G06F 3/044; G06F 3/0416

(57) ABSTRACT

The possibility of occurrence of touch position misrecognition attributable to wall noise is reduced. There is provided a capacitance value estimator circuit (108b) that refers to dummy decoding results and thereby corrects actual decoding results. The dummy decoding results are decoding results for intersections (D6 and D7), and the actual decoding results are decoding results for intersections (D1 to D5).

### TECHNICAL FIELD

The present invention relates to a capacitance value distribution detection circuit that detects the distribution of the capacitance of a plurality of capacitors respectively formed at intersections of a plurality of first signal lines and a plurality of second signal lines and also relates to a touch panel system and an electronic device that use the capacitance value distribution detection circuit. The present invention particularly relates to a capacitance value distribution detection circuit that detects the distribution on the basis of output from a differential amplifier that amplifies a difference between linear sum signals output along adjacent ones of the second signal lines and also relates to a touch panel system and an electronic device that use the capacitance value distribution detection circuit.

### BACKGROUND ART

To date, touch panel controllers that detect the distribution of capacitance of a plurality of capacitors have been known. The capacitors are respectively formed at intersections of a plurality of drive lines and a plurality of sense lines, and the touch panel controllers detect the distribution of output from a differential amplifier that amplifies a difference between linear sum signals output along adjacent ones of the sense lines. Amplifying output signals from the plurality of sense lines by the differential amplifier enables noise immunity of the touch panel controller to be fully enhanced. Such a touch panel controller is disclosed in PTL 1.

FIG. 7 is a circuit diagram illustrating the configuration of a touch panel system 1 including a touch panel controller 3 disclosed in PTL 1. The touch panel system 1 includes a touch panel 2 and the touch panel controller 3. The touch panel 2 includes capacitors C11 to C44 respectively formed at intersections of drive lines DL1 to DL4 and sense lines SL1 to SL4.

The touch panel controller 3 includes a drive circuit 4 that drives the capacitors C11 to C44 along the drive lines DL1 to DL4.

The touch panel controller 3 is provided with a plurality of amplifier circuits 7 each connected to two adjacent ones of the sense lines SL1 to SL4. Along the sense lines SL1 to SL4, the amplifier circuits 7 read a plurality of linear sum signals based on the capacitors C11 to C44 driven by the drive circuit 4 and amplify the linear sum signals. Each amplifier circuit 7 receives the linear sum signals from the two corresponding connected ones of the sense lines SL1 to SL4 and amplifies a difference between the linear sum signals. The amplifier circuit 7 includes a differential amplifier 18, integral capacitors Cint, and reset switches. Each integral capacitor Cint is connected to the differential amplifier 18 in parallel to the corresponding reset switch. The differential amplifier 18 receives and amplifies the linear sum signals read along the mutually adjacent sense lines.

The touch panel controller 3 includes AD converter circuits 13 and decoding arithmetic circuits 8. Each AD converter circuit 13 performs analog-to-digital conversion on output from the corresponding amplifier circuit 7. Each decoding arithmetic circuit 8 estimates the capacitance of corresponding one of the capacitors C11 to C44 on the basis of the output from the amplifier circuit 7 that has undergone the analog-to-digital conversion.

### CITATION LIST

### Patent Literature

PTL 1: International Publication No. 2014/042153 (disclosed on Mar. 20, 2014)

### SUMMARY OF INVENTION

### Technical Problem

In the touch panel system 1 including the amplifier circuits 7 each including the differential amplifier 18, however, the output signal from the differential amplifier 18 is likely to be contaminated with wall noise. The wall noise is noise superposed on the output signal from the differential amplifier 18 and caused by capacitance (so-called self-capacitance) formed between the touch panel 2 and an object in contact with or close to the touch panel 2. The wall noise causes almost uniform variation in the results of decoding for all of the drive lines DL1 to DL4 that is performed by the decoding arithmetic circuits 8. In the touch panel system 1, this adversely affects results of estimation of the capacitance of the capacitors C11 to C44, and the touch position is likely to be wrongly recognized.

The present invention has been made in view of the problem described above and aims to provide a capacitance value distribution detection circuit enabled to reduce the possibility of occurrence of touch position misrecognition attributable to wall noise and also provide a touch panel system and an electronic device that use the capacitance value distribution detection circuit.

### Solution to Problem

To solve the problem described above, a capacitance value distribution detection circuit according to an aspect of the invention detects distribution of capacitance of a plurality of capacitors formed at intersections of first signal lines the number of which is D (D is a plural number) and paired second signal lines. The capacitance value distribution detection circuit includes a drive circuit, a differential amplifier, a decoder circuit, and a correction circuit. Based on a partial code sequence with M rows and D columns of a code sequence with the M rows and N columns (M and N are integers satisfying D<N≦M), the drive circuit parallelly drives the plurality of capacitors. The differential amplifier reads, along the paired second signal lines, linear sum signals based on charges stored in the capacitors parallelly driven by the drive circuit, amplifies a difference between the linear sum signals, and outputs the difference. Based on an inner product of output from the differential amplifier and the code sequence with the M rows and the N columns, the decoder circuit decodes the output from the differential amplifier. The correction circuit refers to dummy decoding results and corrects actual decoding results among results of decoding performed by the decoder circuit. The dummy decoding results are decoding results for a residual code sequence obtained by removing the partial code sequence with the M rows and the D columns from the code sequence with the M rows and the N columns. The actual decoding results are decoding results for the partial code sequence with the M rows and the D columns.

### Advantageous Effects of Invention

According to the aspect of the invention, the possibility of occurrence of touch position misrecognition attributable to wall noise can be reduced.

### BRIEF DESCRIPTION OF DRAWINGS

FIG. 1 is a circuit diagram illustrating a touch panel system according to Embodiment 1 of the invention.

FIGS. 2(a) and (b) is a diagram explaining a wall noise occurrence mechanism.

FIGS. 3(a) and (b) illustrates graphs by which results of decoding with almost no wall noise are compared with results of decoding with high wall noise.

FIG. 4 is a diagram illustrating a decoding operation.

FIG. 5 is a graph explaining correction performed by a capacitance value estimator circuit when a component B is not negligible compared with a component A (described later).

FIG. 6 is a circuit diagram illustrating the configuration of a touch panel system according to Embodiment 2 of the invention.

FIG. 7 is a circuit diagram illustrating the configuration of a touch panel system including a touch panel controller according to a related art.

FIG. 8 is a block diagram illustrating the configuration of an electronic device according to Embodiment 3 of the invention.

### DESCRIPTION OF EMBODIMENTS

[Wall Noise Occurrence Mechanism]

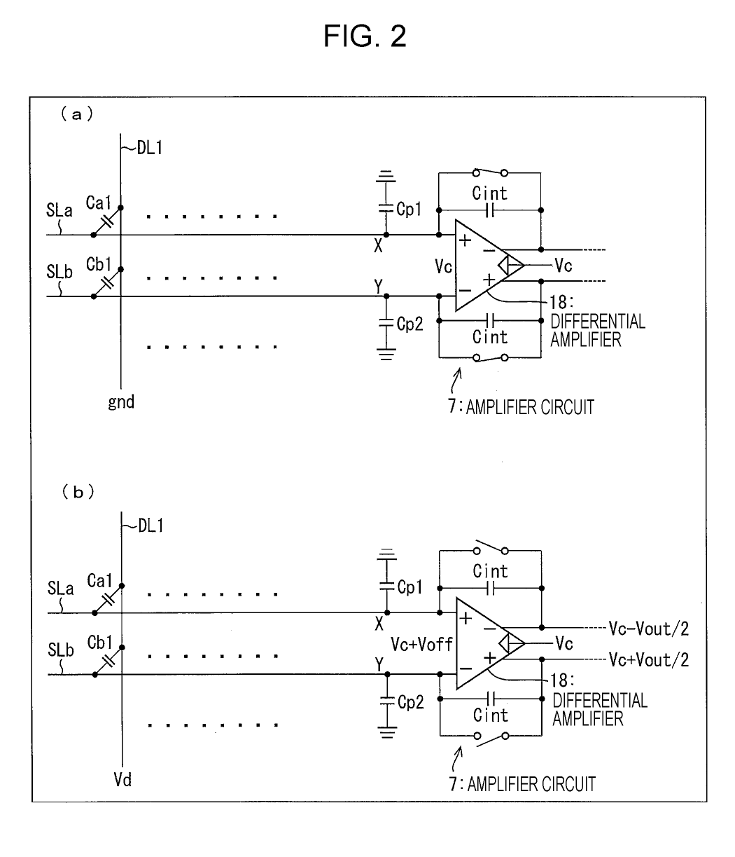

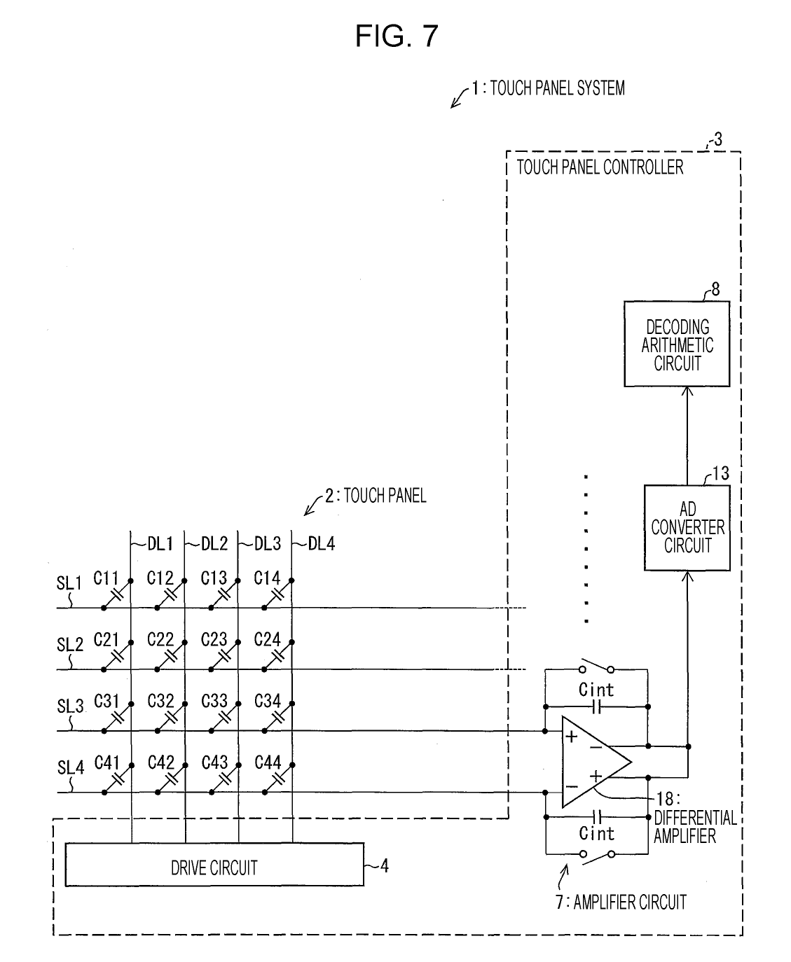

A wall noise occurrence mechanism will be described with reference to FIGS. 2(a) and (b) and FIG. 7.

FIGS. 2(a) and (b) is a diagram explaining the wall noise occurrence mechanism with reference to the amplifier circuit 7 illustrated in FIG. 7. FIG. 2(a) illustrates a reset state of the amplifier circuit 7, and FIG. 2(b) illustrates an integrated state of the amplifier circuit 7.

In FIGS. 2(a) and (b), capacitors Ca1 and Cb1 form so-called mutual-capacitance. The capacitor Ca1 represents a capacitor formed at the intersection of a sense line SLa that is one of the sense lines SL1 to SL4 and a drive line DL1 crossing the sense line SLa. Likewise, the capacitor Cb1 represents a capacitor formed at the intersection of a sense line SLb that is one of the sense lines SL1 to SL4 and that is adjacent to the sense line SLa and the drive line DL1 crossing the sense line SLb. That is, each of the capacitors Ca1 and Cb1 corresponds to one of the capacitors C1 to C41 (see FIG. 7) and is needed from the viewpoint of the operating principal of a touch panel system using a capacitance system.

In contrast, in FIGS. 2(a) and (b), each of capacitance Cp1 and capacitance Cp2 is a capacitive component between corresponding one of the sense lines SLa and SLb and an AC ground node. The capacitance Cp1 and the capacitance Cp2 are, for example, (parasitic) capacitive components, so-called self-capacitance, or the like. The (parasitic) capacitive components are formed in a case where the sense lines SLa and SLb are arranged on one of two layers of a two-layer printed circuit board (not illustrated), where a solid GND plane is arranged on the other layer, and where the sense lines SLa and SLb are wired to the solid GND plane. The self-capacitance is formed between the touch panel 2 and an object in contact with or close to the touch panel 2. A change in the capacitance of the capacitance Cp1 and the capacitance Cp2 can prevent operation of a touch panel system using a mutual capacitance system and preferably does not occur. However, each of the capacitance Cp1 and the capacitance Cp2 is a sort of parasitic capacitance, and it is difficult to prevent occurrence of the change in the capacitance of the capacitance Cp1 and the capacitance Cp2.

A common mode voltage Vc is applied to input terminals of the differential amplifier 18 of the amplifier circuit 7. As illustrated in FIG. 2(a), when the amplifier circuit 7 is in the reset state, the drive line DL1 is grounded, and the reset switches are short-circuited.

When the amplifier circuit 7 enters the integrated state, as illustrated in FIG. 2(b), a drive voltage Vd is applied to the drive line DL1 (the drive line DL1 is driven), the reset switches are released.

Note that Formula (1) below holds true based on charge storage in a node X illustrated in FIGS. 2(a) and (b). In addition, Formula (2) below holds true based on charge storage in a node Y illustrated in FIGS. 2(a) and (b).

(Ca1+Cp1)Vc=Ca1(Vc+Voff−Vd)+Cp1(Vc+Voff)+Cint(Voff+Vout/2) (1)

(Cb1+Cp2)Vc=Cb1(Vc+Voff−Vd)+Cp2(Vc+Voff)+Cint(Voff−Vout/2) (2)

An offset voltage Voff of the amplifier circuit 7 in the integrated state is thereby obtained in accordance with Formula (3) below. In addition, an output Vout from the amplifier circuit 7 in the integrated state of the amplifier circuit 7 is obtained in accordance with Formula (4) below.

Voff=(Ca1+Cb1)Vd/(Ca1+Cb1+Cp1+Cp2+2Cint) (3)

Vout={(Ca1−Cb1)(Vd−Voff)−(Cp1−Cp2)Voff}/Cint (4)

According to Formula (4), the output Vout includes a component proportional to a capacitance difference between the capacitors Ca1 and Cb1 that form mutual-capacitance and also includes a component proportional to the capacitance difference between the capacitance Cp1 and the capacitance Cp2. That is, the output Vout is changed depending on the change in the capacitance between the capacitance Cp1 and the capacitance Cp2. It can be said that noise causing the change of the output Vout is wall noise.

Note that if the offset voltage Voff is sufficiently smaller than the drive voltage Vd, and if Cp1=Cp2 holds true, the output Vout in Formula (5) below can be obtained.

Vout=(Ca1−Cb1)Vd/Cint (5)

Hereinafter, a component corresponding to (Ca1−Cb1)(Vd−Voff) proportional to a capacitance difference in the output Vout between the capacitors Ca1 and Cb1 is referred to as a component A, and a component corresponding to −(Cp1−Cp2) Voff proportional to a capacitance difference between the capacitance Cp1 and the capacitance Cp2 is referred to as a component B.

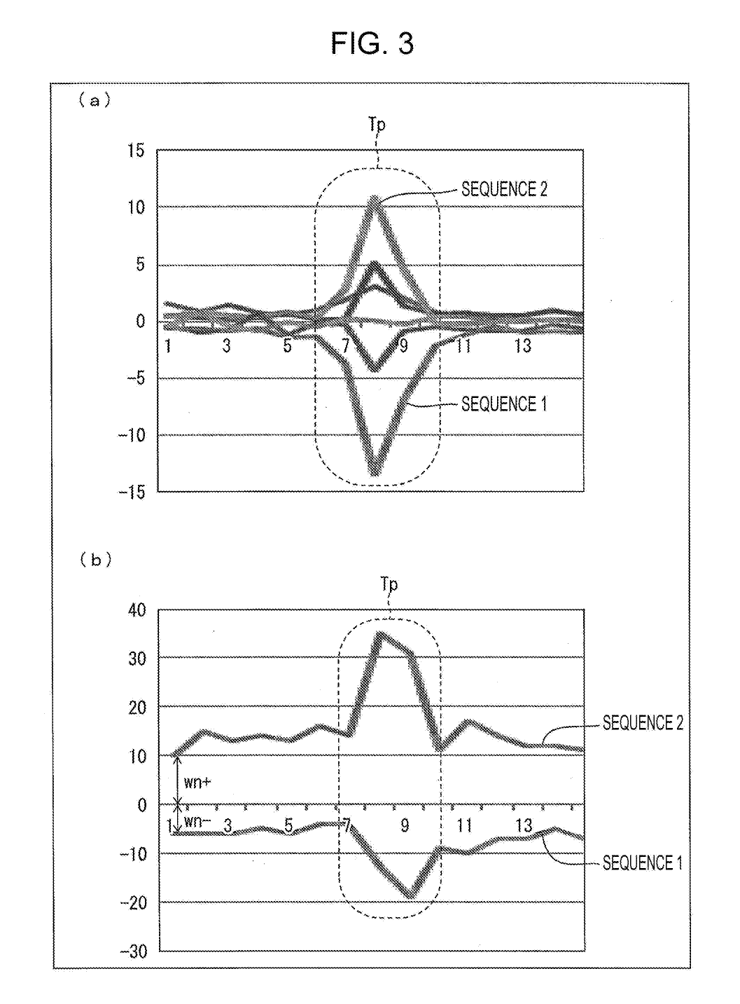

FIGS. 3(a) and (b) illustrates graphs by which results of decoding with almost no wall noise (FIG. 3(a)) are compared with results of decoding with high wall noise (FIG. 3(b)). In FIGS. 3(a) and (b), the horizontal axis represents the drive line positions for decoding results, and the vertical axis represents the magnitude of the decoding results. FIG. 3(a) and FIG. 3(b) illustrate the same positions (range) of a touch position Tp along the horizontal axis.

In FIG. 3(a), the decoding results take on values close to 0 except the touch position Tp. In contrast, in FIG. 3(b), the wall noise causes the decoding results to take on large values in the case of positive output involved with a touch and to take on small values in the case of negative output. Note that the values of decoding results as described above are changed regardless of whether the decoding results are within the range of the touch position Tp and are changed to the same degree at all of the drive line positions (wn+ and wn− in FIG. 3(b)).

The conditions for obtaining decoding results with almost no wall noise illustrated in FIG. 3(a) are that, for example, the code length is 15 and that the total number of driven drive lines is 15.

In FIGS. 3(a) and (b), “Sequence 1” is, for example, a difference between a linear sum signal from a sense line SL4 and a linear sum signal from a sense line SL3 in Embodiment 1 (described later). In addition, in FIGS. 3(a) and (b), “Sequence 2” is a difference between a linear sum signal from a sense line SL6 and a linear sum signal from a sense line SL5 in Embodiment 1 (described later).

### Embodiment 1

For convenience of description, members denoted by the same reference numerals as those used for the members described before have the same functions, and description thereof will be omitted.

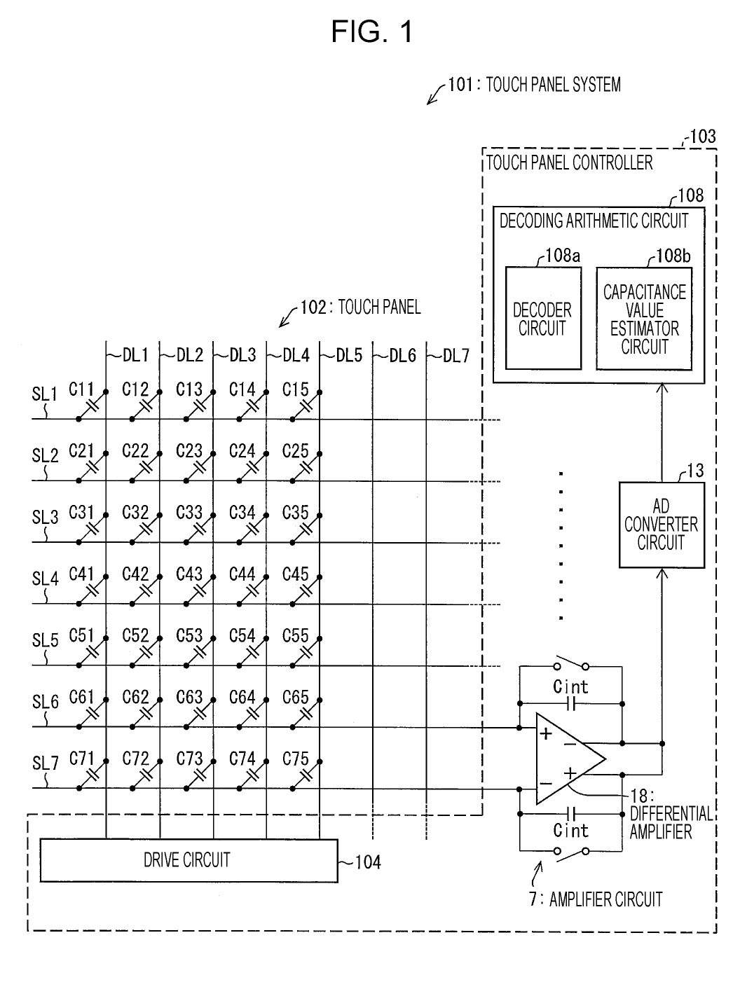

FIG. 1 is a circuit diagram illustrating the configuration of a touch panel system 101 including a capacitance value distribution detection circuit according to this embodiment. The touch panel system 101 includes a touch panel 102 and a touch panel controller 103. The touch panel 102 includes drive lines DL1 to DL7 and sense lines (second signal lines) SL1 to SL7. The touch panel 102 also includes capacitors C11 to C75 formed at intersections of the drive lines (first signal lines) DL1 to DL5 and the sense lines SL1 to SL7.

The touch panel controller 103 includes a drive circuit 104 that drives the capacitors C11 to C75 along the drive lines DL1 to DL5. Note that the drive circuit 104 parallelly drives the drive lines DL1 to DL5 among the drive lines DL1 to DL7, while the drive circuit 104 does not drive the drive lines DL6 and DL7.

The drive circuit 104 parallelly drives the drive lines DL1 to DL5 on the basis of a code sequence having rows (M rows) and columns (N columns) the number of each of which is larger than the number of parallelly driven drive lines DL1 to DL5 (D lines). For example, the drive circuit 104 drives the drive lines DL1 to DL5 on the basis of seven rows and five columns (M rows and D columns) of an orthogonal code sequence with the seven rows and seven columns (M rows and N columns) (code length: 7).

The touch panel controller 103 is provided with a plurality of amplifier circuits 7 each connected to adjacent two of the sense lines SL1 to SL7. Along the sense lines SL1 to SL7, the amplifier circuits 7 read and amplify a plurality of linear sum signals based on charges stored in the capacitors C11 to C75 driven by the drive circuit 104. Each amplifier circuit 7 receives linear sum signals from the two corresponding connected ones of the sense lines SL1 to SL7 (paired second signal lines) and amplifies a difference between the linear sum signals. The amplifier circuit 7 includes a differential amplifier 18, integral capacitors Cint, and reset switches. Each integral capacitor Cint is connected to the differential amplifier 18 in parallel to the corresponding reset switch. The differential amplifier 18 receives and amplifies the linear sum signals read along the mutually adjacent sense lines.

The touch panel controller 103 includes AD converter circuits (analog-to-digital converter circuits) 13 and decoding arithmetic circuits 108. Each AD converter circuit 13 performs analog-to-digital conversion on output from the corresponding amplifier circuit 7. Each decoding arithmetic circuit 108 estimates the capacitance of corresponding one of the capacitors C11 to C75 on the basis of the output from the amplifier circuit 7 that has undergone the analog-to-digital conversion.

Each decoding arithmetic circuit 108 includes a decoder circuit 108a and a capacitance value estimator circuit (correction circuit) 108b. The decoder circuit 108a decodes the output from the amplifier circuit 7 on the basis of an inner product operation performed between the signal output from the amplifier circuit 7 that has undergone the analog-to-digital conversion and the orthogonal code sequence with the seven rows and seven columns. The capacitance value estimator circuit 108b refers to results of decoding (dummy decoding results) performed by the decoder circuit 108a for the intersections of the drive lines DL6 and DL7 and the sense lines SL1 to SL7 and corrects results of decoding (actual decoding results) performed by the decoder circuit 108a for the intersections of the drive lines DL1 to DL5 and the sense lines SL1 to SL7. The capacitance value estimator circuit 108b then estimates the capacitance of the capacitors C11 to C75. The actual decoding results are decoding results for a partial code sequence with the seven rows and five columns. The dummy decoding results are decoding results for a code sequence (residual code sequence) obtained by removing the partial code sequence with the seven rows and five columns from the code sequence with the seven rows and seven columns.

(Decoding Operation and Wall Noise Component Identification)

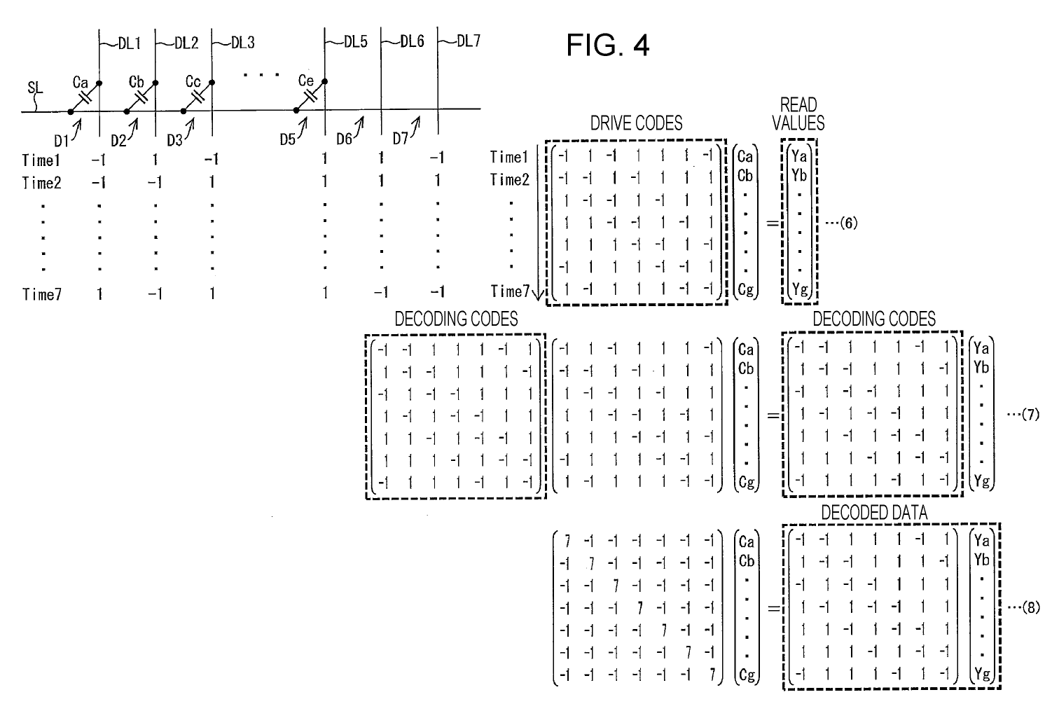

FIG. 4 is a diagram illustrating a decoding operation.

In FIG. 4, a sense line SL that is one of the sense lines SL1 to SL7 is focused.

For example, in the touch panel system 101, the capacitors are driven by using the seven rows and five columns of m-sequence codes with seven rows and seven columns, and capacitance thereof can thereby be estimated. As described in Formula (6) to Formula (8), the inner product of read values Ya to Yg and the m-sequence codes with the seven rows and seven columns is calculated. The read values Ya to Yg are linear sum signals. The capacitance of capacitors Ca to Ce can thereby be estimated. An “m-sequence” is a sort of Boolean pseudo-random number sequence and uses only two values of 1 and -1 (or 1 and 0). The length of one cycle of the m-sequence is 2ⁿ−1. Examples of an m-sequence having the length=2³−1=7 include “1, −1, −1, 1, 1, 1, −1”. An example in which the drive circuit 104 parallelly drives the drive lines DL1 to DL5 on the basis of an orthogonal code sequence with seven rows and seven columns will herein be described.

The capacitors Ca to Ce are respectively formed at the intersections of the sense line SL and the drive lines DL1 to DL5. The capacitors Ca to Ce form mutual-capacitance and correspond to the capacitors C11 to C15, the capacitors C21 to C25, . . . or the capacitors C71 to 75 (see FIG. 1).

The drive circuit 104 (see FIG. 1) parallely drives the drive lines DL1 to DL5 at Time1 to Time7, that is, seven times and does not drive the drive lines DL6 and DL7. Corresponding one of the amplifier circuits 7 reads linear sum signals (read values Ya to Yg) output from the sense line SL every parallel driving. A relationship at this time among the capacitance of the capacitors Ca to Ce and the read values Ya to Yg corresponds to Formula (6) in FIG. 4. Note that a matrix in seven rows and seven columns in the left side of Formula (6) represents drive codes for the drive circuit 104 to drive the drive lines DL1 to DL5. The rows of the drive codes correspond to the respective parallel driving operations performed seven times, and the columns of the drive codes correspond to the respective drive lines DL1 to DL7. Note that in the configuration, drive codes are assigned to the drive lines DL6 and DL7, and virtual capacitors Cf and Cg are respectively present at the intersections of the sense line SL and the drive lines DL6 and DL7. The configuration is provided to enable calculation of the matrix in seven rows and seven columns in accordance with Formula (6). It goes without saying that the drive lines DL6 and DL7 are not driven and do not have capacitors in actuality.

The decoder circuit 108a of the decoding arithmetic circuit 108 (see FIG. 1) performs decoding (Formula (7)) in such a manner as to multiply each of the left and right sides of Formula (6) by a transposed matrix (decoding codes) of the aforementioned drive codes from the left (perform the inner product operation).

The left side of Formula (8) expresses an inner product obtained from the left side of Formula (7) by multiplying the decoding codes (the transposed matrix of the drive codes) and the drive codes. The right side of Formula (8) corresponds to data after decoding performed by the decoder circuit 108a.

Hereinafter, the principle of identifying a wall noise component in the touch panel system 101 will be described. A case where the code length is 7 and where only the drive lines DL1 to DL5 of the drive lines DL1 to DL7 are driven will herein be described as an example. In addition, the intersections of the sense line SL and the drive lines DL1 to DL7 are herein referred to as intersections D1 to D7, respectively.

Assume that the intersection D3 is touched. In this case, a change in the capacitance of the capacitor Cc at the intersection D3 leads to a change in the level of the linear sum signal output from the sense line SL, and the presence of self-capacitance at the intersections D1 to D5 leads to a change in the level of the linear sum signal. Elements involving level changes in the linear sum signals are respectively represented as below for the intersections D1 to D7 by using A3 that denotes signal variation related to the component A and B1, B2, B3, B4, and B5 that each denote signal variation related to the component B.

Intersection D1: B1

Intersection D2: B2

Intersection D3: A3+B3

Intersection D4: B4

Intersection D5: B5

Intersection D6: 0 (because the drive line DL6 is not driven and a signal is thus considered not to be output)

Intersection D7: 0 (because the drive line DL7 is not driven and a signal is thus considered not to be output)

The decoder circuit 108a of the decoding arithmetic circuit 108 performs decoding, and the decoding results for the respective intersections D1 to D7 are thereby obtained from the linear sum signals. That is, the decoding results for the respective intersections D1 to D7 are as follows (for simplicity in the description, elements involving level changes in the linear sum signals corresponding to the respective intersections D1 to D7 are respectively denoted by D1 to D7). For simplicity, A3=A AND B1=B2=B3=B4=B5=B herein holds true.

Decoding result (for intersection D1): +7D1−D2−D3−D4−D5−D6−D7=+7B1−B2−(A3+B3)−B4−B5−0−0=−A+3B

Decoding result (for intersection D2): −D1+7D2−D3−D4−D5−D6−D7=−B1+7B2−(A3+B3)−B4−B5−0−0=−A+3B

Decoding result (for intersection D3): −D1−D2+7D3−D4−D5−D6−D7=−B1−B2+7(A3+B3)−B4−B5−0−0=7A+3B

Decoding result (for intersection D4): −D1−D2−D3+7D4−D5−D6−D7=−B1−B2−(A3+B3)+7B4−B5−0−0=−A+3B

Decoding result (for intersection D5): −D1−D2−D3−D4+7D5−D6−D7=−B1−B2−(A3+B3)−B4+7B5−0−0=−A+3B

Decoding result (for intersection D6): −D1−D2−D3−D4−D5+7D6−D7=−B1−B2−(A3+B3)−B4−B5+0−0=−A−5B

Decoding result (for intersection D7): −D1−D2−D3−D4−D5−D6+7D7=−B1−B2−(A3+B3)−B4−B5−0+0=−A−5B

That is, a component having 3B is observed in each decoding result for corresponding one of the intersections D1 to D5 where the respective drive lines DL1 to DL5 are driven. Speaking based on generalization, a component having “(code length−the total number of driven drive lines+1)×B” is observed in a decoding result (true decoding result) for an intersection where a corresponding drive line is driven.

In contrast, a component having −5B is observed in each decoding result for corresponding one of the intersections D6 and D7 where the respective drive lines DL6 and DL7 are not driven. Speaking based on generalization, a component based on “(−the total number of driven drive lines)×B” is observed in a decoding result (dummy decoding result) for an intersection where a corresponding drive line is not driven.

If the component A>>the component B, and if the component B is negligible compared with the component A, decoding results for the respective intersections D1, D2, D4, D5, D6, and D7 other than the intersection D3 having a signal change related to the component A each have −A, and a component that has not been present at an intersection involving the signal change is present.

In contrast, if the component B is not negligible compared with the component A, decoding results for the respective intersections D1, D2, D4, and D5 other than the intersection D3 having the signal change related to the component A each have a B component having+3B, and decoding results for the respective intersections D6 and D7 each have a B component having −5B. In other words, in addition to an originally desirably detected signal change related to the component A, decoding results for the intersections D1 to D5 exhibit contamination of a wall noise component having+3B, and decoding results for the intersections D6 and D7 exhibit contamination of a wall noise component having −5B.

(Correcting Decoding Results for Intersections D1 to D5)

The capacitance value estimator circuit 108b first obtains an average value of the decoding results for the intersections D6 and D7. Note that the obtaining the average value by the capacitance value estimator circuit 108b is only one of most preferable examples, and the capacitance value estimator circuit 108b may select one of the decoding results for the intersections D6 and D7.

If the component B is negligible compared with the component A, the capacitance value estimator circuit 108b subtracts the average value from each of the decoding results for the intersections D1 to D5. In this manner, the capacitance value estimator circuit 108b corrects the decoding results for the intersections D1 to D5.

If the component B is not negligible compared with the component A, the capacitance value estimator circuit 108b calculates variation based on the average value. The variation is obtained from the average value and corresponds to B (proportionality constant). The capacitance value estimator circuit 108b subtracts a component proportional to B in each of the decoding results for the intersections D1 to D5 from each of the decoding results for the intersections D1 to D5. In this manner, the capacitance value estimator circuit 108b corrects the decoding results for the intersections D1 to D5.

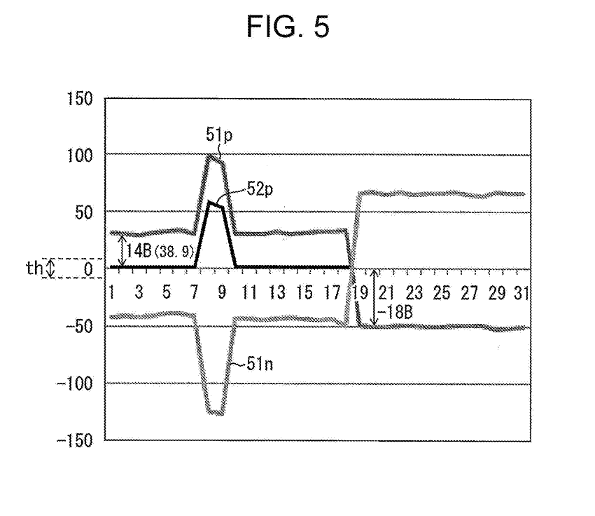

The correction performed by the capacitance value estimator circuit 108b in the case where the component B is not negligible compared with the component A will be described in detail with reference to a graph illustrated in FIG. 5. The graph in FIG. 5 illustrates a case where the code length is 31 and where the total number of driven drive lines is 18. In the graph illustrated in FIG. 5, the horizontal axis represents the numbers assigned to intersections of a sense line and drive lines, and the vertical axis represents the value of decoding results. In the graph illustrated in FIG. 5, drive lines having Nos. 1 to 18 intersections are driven, and drive lines having Nos. 19 to 31 intersections are not driven.

If the code length is 31, and if the total number of driven drive lines is 18, a component having 14B is observed in decoding results for Nos. 1 to 18 intersections, and a component having −18B is observed in decoding results for Nos. 19 to 31 intersections.

Note that regarding decoding results (a polygonal line) 51p that are positive, the decoding results for Nos. 19 to 31 intersections are approximately −50 and uniform. Based on this, if an average value of the decoding results for Nos. 19 to 31 intersections is −50, the variation based on the average value corresponding to B is expressed as −50/−18, and a component having 14B that is proportional to B and that is included in the decoding results for Nos. 1 to 18 intersections is expressed as 14·−50/−18, that is, about 38.9.

The capacitance value estimator circuit 108b subtracts 38.9 corresponding to 14B from each decoding result (polygonal line) 51p and obtains decoding results (polygonal line) 52p having undergone the correction.

Note that also regarding decoding results (a polygonal line) 51n that are negative, the variation corresponding to the component having 14B in the decoding results that is obtained in the same steps as described above may be subtracted from each decoding result (polygonal line) 51n.

The steps of correcting the decoding results (polygonal line) 51n are the same as those for correcting the decoding results (polygonal line) 51p, and detailed description thereof is omitted.

In a case where whether the component B is negligible compared with the component A is not known, the capacitance value estimator circuit 108b performs corrections that are a correction (first correction) for a case where the component B is negligible compared with the component A and a correction (second correction) for a case where the component B is not negligible compared with the component A. By using one of the corrections that causes more values of the decoding results for Nos. 1 to 18 intersections (corresponding to estimated capacitance values of the capacitors) to fall within a predetermined numerical value range th, the decoding results for Nos. 1 to 18 intersections may be corrected. As the predetermined numerical value range th, a range allowable for values of the decoding results for Nos. 1 to 18 intersections may appropriately set.

As described above, more appropriate one of the corrections performed for the case for the component B is negligible compared with the component A and for the case where the component B is not negligible compared with the component A is selected, more accurate correction can be performed.

The touch panel system 101 can correct a change of a decoding result attributable to wall noise and can thus reduce the possibility of occurrence of touch position misrecognition attributable to wall noise.

In other words, the touch panel system 101 refers to the decoding results for the intersections D6 and D7 to correct the decoding results for the intersections D1 to D5 and thus can identify a wall noise component from linear sum signals. The decoding results for the intersections D1 to D5 are corrected in such a manner that the identified wall noise component is excluded, and the possibility of occurrence of touch position misrecognition attributable to wall noise can be reduced.

If the total number of parallelly driven drive lines is D, and if the code sequence has M rows and N columns, D may be plural, and D, M, and N may be integers satisfying D<N≦M.

### Embodiment 2

For convenience of description, members denoted by the same reference numerals as those used for the members described before have the same functions, and description thereof will be omitted.

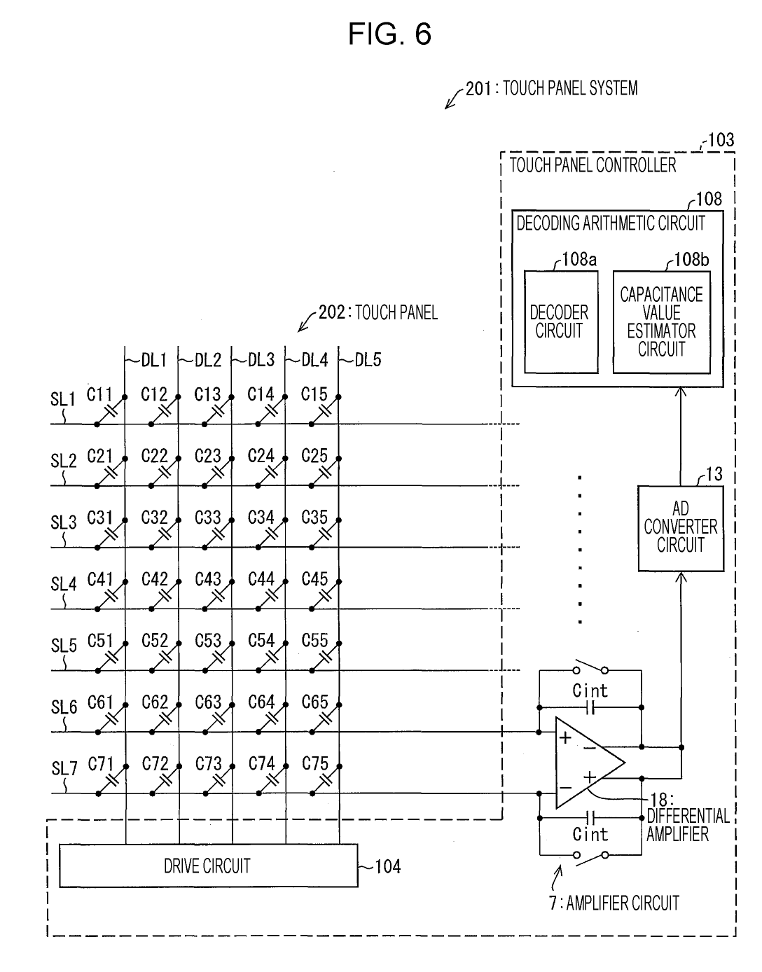

FIG. 6 is a circuit diagram illustrating the configuration of a touch panel system 201 including a capacitance value distribution detection circuit according to this embodiment.

The touch panel system 201 illustrated in FIG. 6 is different from the touch panel system 101 illustrated in FIG. 1 in that the touch panel system 201 includes a touch panel 202 instead of the touch panel 102. The configuration thereof except this is the same as that of the touch panel system 101. The touch panel 202 illustrated in FIG. 6 is different from the touch panel 102 illustrated in FIG. 1 in that the touch panel 202 does not include the drive lines DL6 and DL7. The configuration thereof except this is the same as that of the touch panel 102.

Elements involving level changes in the linear sum signals are represented by 0 for the intersections of the sense lines SL1 to SL7 and the drive lines DL6 and DL7. In other words, the presence or absence of the drive lines DL6 and DL7 does not influence the linear sum signals in theory.

Based on this, the drive lines DL6 and DL7 may be omitted. In other words, the drive lines DL6 and DL7 may be treated as insubstantial and virtual drive lines (not driven).

Since the drive lines DL6 and DL7 are omitted in the touch panel system 201, downsizing and cost reduction in a touch panel is expected as compared with the touch panel system 101.

[Addition]

The invention may be construed as a capacitance value distribution detection circuit including the drive circuit 104, the amplifier circuits 7 each including the differential amplifier 18, the AD converter circuits 13, and the decoding arithmetic circuits 108 each including the decoder circuit 108a and the capacitance value estimator circuit 108b because combining the capacitance value distribution detection circuit with the touch panel 102 or 202 enables the same advantageous effect as that of the touch panel system 101 or 201 to be obtained.

### Embodiment 3

An electronic device including the touch panel system 101 also falls under the category of the invention. A mobile phone or the like can be cited as the electronic device.

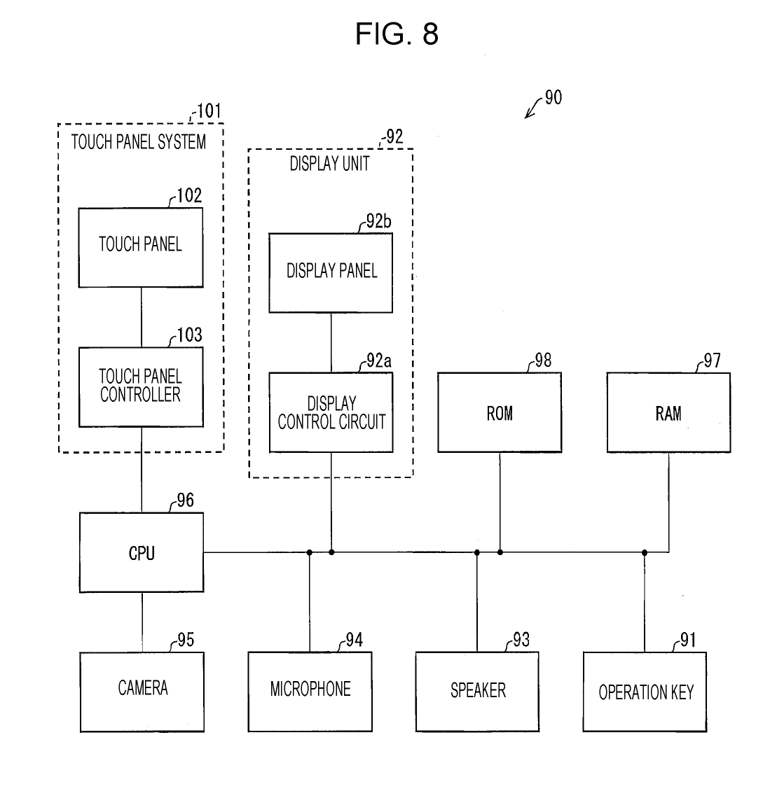

FIG. 8 is a block diagram illustrating the configuration of a mobile phone (electronic device) 90 according to this embodiment. The mobile phone 90 includes a CPU 96, a RAM 97, a ROM 98, a camera 95, a microphone 94, a speaker 93, an operation key 91, a display unit 92 including a display panel 92b and a display control circuit 92a, and the touch panel system 101. The components are mutually connected through a data bus.

The CPU 96 controls operation of the mobile phone 90. The CPU 96 runs programs stored in, for example, the ROM 98. The operation key 91 receives instruction input from a user of the mobile phone 90. The RAM 97 stores, in a volatile manner, data generated by running any one of the programs by the CPU 96 or data input through the operation key 91. The ROM 98 stores data in a nonvolatile manner.

The ROM 98 is a writable and erasable ROM such as an EPROM (Erasable Programmable Read-Only Memory) or a flash memory. Although not illustrated in FIG. 8, the mobile phone 90 may include an interface (IF) for connecting to another electronic device in a wired manner.

The camera 95 takes an image regarding a subject in response to a user operation of the operation key 91. Note that image data of the photographed subject is stored in the RAM 97 or an external memory (for example, a memory card). The microphone 94 receives input of the voice of the user. The mobile phone 90 digitizes the input voice (analog data). The mobile phone 90 transmits the digitized voice to a communication counterpart (for example, another mobile phone). The speaker 93 outputs sound based on music data or the like stored, for example, in the RAM 97.

The touch panel system 101 includes the touch panel 102 and the touch panel controller 103. The CPU 96 controls operation of the touch panel system 101.

The display panel 92b displays an image stored in the ROM 98 or the RAM 97 in accordance with the display control circuit 92a. The display panel 92b is stacked on the touch panel 102 or incorporates therein the touch panel 102.

As a matter of course, the combination of the touch panel system 101 with the touch panel 102 may be changed to the combination of the touch panel system 201 with the touch panel 202.

(Summarization)

A capacitance value distribution detection circuit according to an aspect of the invention detects distribution of capacitance of a plurality of capacitors formed at intersections of first signal lines (drive lines DL 1 to DL5) the number of which is D (5) (D is a plural number) and paired second signal lines (sense lines SL1 to SL7). The capacitance value distribution detection circuit includes a drive circuit, a differential amplifier, a decoder circuit, and a correction circuit (capacitance value estimator circuit 108b). Based on a partial code sequence with M rows and D columns (seven rows and five columns) of a code sequence with the M rows and N columns (the seven rows and seven columns) (M and N are integers satisfying D<N≦M), the drive circuit parallelly drives the plurality of capacitors. The differential amplifier reads, along the paired second signal lines, linear sum signals based on charges stored in the capacitors parallelly driven by the drive circuit, amplifies a difference between the linear sum signals, and outputs the difference. Based on an inner product of output from the differential amplifier and the code sequence with the M rows and the N columns, the decoder circuit decodes the output from the differential amplifier. The correction circuit refers to dummy decoding results and corrects actual decoding results among results of decoding performed by the decoder circuit. The dummy decoding results are decoding results for a residual code sequence obtained by removing the partial code sequence with the M rows and the D columns from the code sequence with the M rows and the N columns. The actual decoding results are decoding results for the partial code sequence with the M rows and the D columns.

According to the configuration, the dummy decoding results are referred to and the actual decoding results are corrected. A wall noise component can thus be identified from the linear sum signals. The actual decoding results are corrected in such a manner that the identified wall noise component is excluded, and the possibility of occurrence of touch position misrecognition attributable to wall noise can thereby be reduced.

In the capacitance value distribution detection circuit according to another aspect of the invention, the correction circuit corrects each of the actual decoding results by subtracting an average value of the dummy decoding results from the actual decoding result.

In the capacitance value distribution detection circuit according to still another aspect of the invention, the correction circuit calculates variation based on an average value of the dummy decoding results. The variation is obtained from the average value and corresponds to a proportionality constant (B). The correction circuit corrects each of the actual decoding results by subtracting, from the actual decoding result, a component proportional to the proportionality constant in the actual decoding result.

According to the configuration, the actual decoding results can be corrected based on the average value of the plurality of dummy decoding results.

In the capacitance value distribution detection circuit according to still another aspect of the invention, the correction circuit is capable of a first correction and a second correction. The first correction is performed by correcting each of the actual decoding results by subtracting an average value of the dummy decoding results from the actual decoding result. The second correction is performed by correcting the actual decoding result after calculating variation based on the average value of the dummy decoding results. The variation is obtained from the average value and corresponds to a proportionality constant. The actual decoding result is corrected by subtracting, from the actual decoding result, a component that is included in the actual decoding result and that is proportional to the proportionality constant. The correction circuit corrects the actual decoding result by using one of the first correction and the second correction. The used one causes more estimated values of the capacitance of the plurality of capacitors to fall within a predetermined numerical value range.

According to the configuration, one of the first correction and the second correction that results in more appropriate correction is selected, and more accurate correction can be performed.

A touch panel system according to still another aspect of the invention includes the capacitance value distribution detection circuit according to any one of the aspects.

An electronic device according to still another aspect of the invention includes the touch panel system.

According to the configuration, like the capacitance value distribution detection circuit according to each aspect of the invention, the possibility of occurrence of touch position misrecognition attributable to wall noise can be reduced.

The invention is not limited to the embodiments described above, and various modifications may be made within the scope of claims. An embodiment obtained by appropriately combining technical means disclosed in the different embodiments also falls within the technical scope of the invention. Further, combination of the technical means disclosed in the embodiments may create a new technical feature.

### INDUSTRIAL APPLICABILITY

The invention may be utilized for a capacitance value distribution detection circuit that detects the distribution of the capacitance of a plurality of capacitors respectively formed at intersections of a plurality of first signal lines and a plurality of second signal lines and may also be used for a touch panel system and an electronic device that use the capacitance value distribution detection circuit. The invention may particularly be utilized for a capacitance value distribution detection circuit that detects the distribution on the basis of output from a differential amplifier that amplifies a difference between linear sum signals output along adjacent ones of the second signal lines and may also be utilized for a touch panel system and an electronic device that use the capacitance value distribution detection circuit. A mobile phone can be cited as an example of the electronic device.

### REFERENCE SIGNS LIST

7 amplifier circuit
13 AD converter circuit (analog-to-digital converter circuit)
18 differential amplifier
90 mobile phone (electronic device)
101 touch panel system
104 drive circuit
108a decoder circuit
108b capacitance value estimator circuit (correction circuit)
201 touch panel system
C11 to C75 capacitors
Ca to Ce capacitors
D1 to D5 intersections (intersections of a plurality of first signal lines parallelly driven and a plurality of second signal lines)
D6 and D7 intersections (located differently from the intersections of the plurality of first signal lines parallelly driven and the plurality of second signal lines)
DL1 to DL5 drive lines (first signal lines) SL sense line (second signal line)
SL1 to SL7 sense lines (second signal lines) th predetermined numerical value range

1. A capacitance value distribution detection circuit which detects distribution of capacitance of a plurality of capacitors formed at intersections of first signal lines the number of which is D (D is a plural number) and paired second signal lines, the capacitance value distribution detection circuit comprising:
a drive circuit that parallelly drives, based on a partial code sequence with M rows and D columns of a code sequence with the M rows and N columns (M and N are integers satisfying D<N≦M), the plurality of capacitors;
a differential amplifier that reads, along the paired second signal lines, linear sum signals based on charges stored in the capacitors parallelly driven by the drive circuit, amplifies a difference between the linear sum signals, and outputs the difference;
a decoder circuit that decodes, based on an inner product of output from the differential amplifier and the code sequence with the M rows and the N columns, the output from the differential amplifier; and
a correction circuit that refers to dummy decoding results and corrects actual decoding results among results of decoding performed by the decoder circuit, the dummy decoding results being decoding results for a residual code sequence obtained by removing the partial code sequence with the M rows and the D columns from the code sequence with the M rows and the N columns, the actual decoding results being decoding results for the partial code sequence with the M rows and the D columns.

2. The capacitance value distribution detection circuit according to claim 1,
wherein the correction circuit corrects each of the actual decoding results by subtracting an average value of the dummy decoding results from the actual decoding result.

3. The capacitance value distribution detection circuit according to claim 1,
wherein the correction circuit calculates variation based on an average value of the dummy decoding results, the variation being obtained from the average value and corresponding to a proportionality constant, and the correction circuit corrects each of the actual decoding results by subtracting, from the actual decoding result, a component proportional to the proportionality constant in the actual decoding result.

4. The capacitance value distribution detection circuit according to claim 1,
wherein the correction circuit is capable of a first correction and a second correction, the first correction being performed by correcting each of the actual decoding results by subtracting an average value of the dummy decoding results from the actual decoding result,
the second correction being performed by correcting the actual decoding result after calculating variation based on the average value of the dummy decoding results, the variation being obtained from the average value and corresponding to a proportionality constant, the actual decoding result being corrected by subtracting, from the actual decoding result, a component that is included in the actual decoding result and that is proportional to the proportionality constant, and
wherein the correction circuit corrects the actual decoding result by using one of the first correction and the second correction, the used one causing more estimated values of the capacitance of the plurality of capacitors to fall within a predetermined numerical value range.

5. A touch panel system comprising the capacitance value distribution detection circuit according to claim 1.

6. An electronic device comprising the touch panel system according to claim 5.
